(19) United States
(12) Patent Application Publication
(10) Pub. No.: US 2016/0093299 A1
(43) Pub. Date: Mar. 31, 2016

(54) FILE CLASSIFYING SYSTEM AND METHOD

(71) Applicant: AVerMedia TECHNOLOGIES, INC., NEW TAIPEI CITY (TW)

(72) Inventor: Kuo-Ying SU, NEW TAIPEI CITY (TW)

(21) Appl. No.: 14/845,319

(22) Filed: Sep. 4, 2015

(30) Foreign Application Priority Data
Sep. 30, 2014 (TW) 103134018

(51) Int. Cl. G10L 15/18; G06F 17/30; G10L 25/54

(52) U.S. Cl. CPC G10L 15/1815; G10L 25/54; G06F 17/30017; G10L 2015/088

(57) ABSTRACT

A file classifying system and a file classifying method are disclosed herein, where the system includes a storing device storing at least one recognizing audio signal, a receiving device, and a processor. The receiving device receives an audio file or a video file. The processor compares a related audio signal and the at least one recognizing audio signal so as to generate a result of process, where the related audio signal is correlated to the audio file or the video file, and then automatically classifies the audio file or video file into a category.

### RELATED APPLICATIONS

This application claims priority to Taiwan Application Serial Number 103134018, filed Sep. 30, 2014, which is herein incorporated by reference.

### BACKGROUND

1. Field of Invention

The present disclosure is related to a classifying technology, and more particularly, a file classifying system and a file classifying method.

2. Description of Related Art

The audio or video recording technology has been developed for a long time, wherein most of the developments focus on the improvements and researches of the audio or video recording technology, and few of them associate with the classifying and storing method after the recording is completed.

Generally, an audio file or a video file is usually stored in the same location after audio or video recording completed, and the naming rule often takes similar combinations of English characters and/or numbers in increasing order as a file name; unless users rename the file by themselves, it is difficult to confirm the contents of the file according to the file name. Because of the large number of files without the regular arrangement by the users, it is not an easy task to find a particular file from the numerous files.

### SUMMARY

In order to solve the problems that files cannot be properly classified during the audio or video recording, an aspect of the present disclosure provides a file classifying system, which comprising a storing device, a receiving device and a processor. The storing device stores at least one recognizing audio signal. The receiving device receives an audio file or a video file. The processor compares a related audio signal correlated to the audio file or the video file with the at least one recognizing audio signal so as to generate a result of process, and then automatically classifies the audio file or the video file according to the result of process.

Another aspect of the present disclosure provides a file classifying method, which comprising the following steps: (a) at least one recognizing audio signal is stored; (b) an audio file or a video file is received; and (c) a related audio signal correlated to the audio file or the video file is compared with the at least one recognizing audio signal so as to generate a result of process, and then automatically classify the audio file or the video file according to the result of process.

From the above-mentioned description, the present disclosure originates from method of file classifying improvement and provides a mechanism of file classifying by voice recognition to classify the files rapidly without complicated operations.

The following is detailed description of the above-mentioned contents through embodiments, and provides further explanation of the technical aspects of the present disclosure.

### BRIEF DESCRIPTION OF THE DRAWINGS

In order to make the above-mentioned contents, and other purposes, features, advantages, and embodiments more clear and understandable, with description made to the accompanying drawings as follows:

FIG. 1 is a schematic diagram of a file classifying system according to the first embodiment of the present disclosure;

FIG. 2 is a schematic diagram of a file classifying system according to the second embodiment of the present disclosure;

FIG. 3 is a schematic diagram of a file classifying system according to the third embodiment of the present disclosure;

FIG. 4 is a schematic diagram of a file classifying system according to the fourth embodiment of the present disclosure; and

FIG. 5 is a flow chart of a file classifying method according to the fifth embodiment of the present disclosure.

### DETAILED DESCRIPTION

In order to make the description of the disclosure more detailed and comprehensive, reference will now be made in detail to the accompanying drawings and the following embodiments. However, the provided embodiments are not used to limit the ranges covered by the present disclosure; orders of step description are not used to limit the execution sequence either. Any devices with equivalent effect through rearrangement are also covered by the present disclosure.

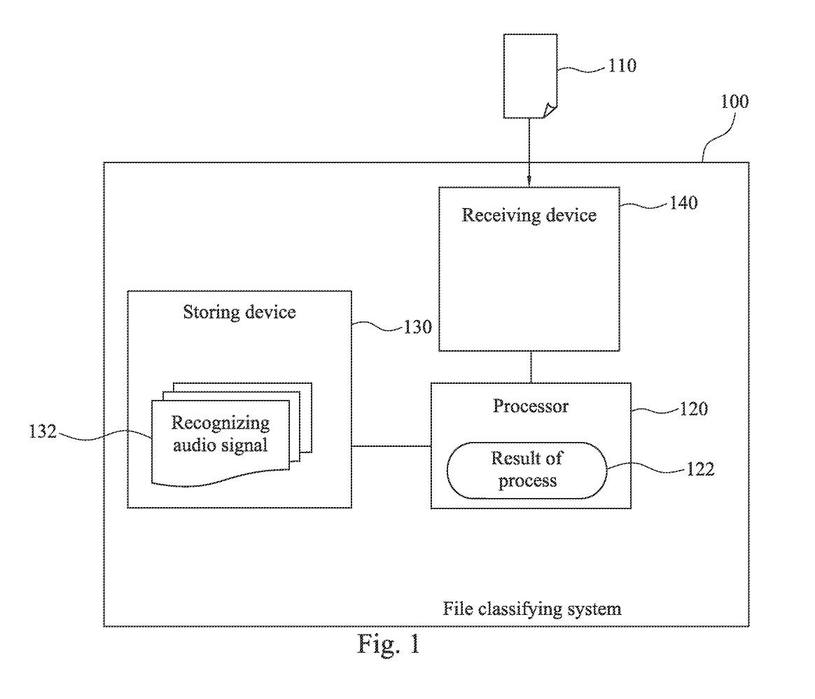

FIG. 1 shows a file classifying system 100 according to the first embodiment of the present disclosure. The file classifying system 100 includes a storing device 130, a receiving device 140 and a processor 120. In practice, the storing device 130 can be hard drives, flash memories or other storing media; the receiving device 140 can be at least one transmission port, which can be with wires and/or wireless, digital and/or analog (for example: HDMI, USB, 3.5 mm, and so forth) built-in or externally connected to the audio and/or video recording devices according to the actual demands; the processor 120 can be CPUs, microprocessors or other circuits.

Before the audio or video recording, users (for example: speakers) can take a previously recorded audio as a recognizing audio signal 132 and store it in a storing device 130; that is, the storing device 130 stores the recognizing audio signal 132. When the audio or video recording is completed, a receiving device 140 receives an audio file or a video file 110; after the file classifying system 100 shows a request notification or the speakers select an audio category, a processor 120 compares a related audio signal correlated to the audio file or the video file 110 with the at least one recognizing audio signal 132 so as to generate a result of process 122, wherein the result of process 122 includes information of suggested classification, and then the processor 120 automatically classifies the audio file or the video file 110 according to the result of process 122. For example, if the related audio signal and the recognizing audio signal 132 are matched, which indicates that the audio file or the video file 110 is the speaker's individual audio or video recording information; therefore, the processor 120 automatically classifies the audio file or the video file 110 into the customized category by the speaker in the storing device 130; consequently, the complicatedly manual operation can be avoided.

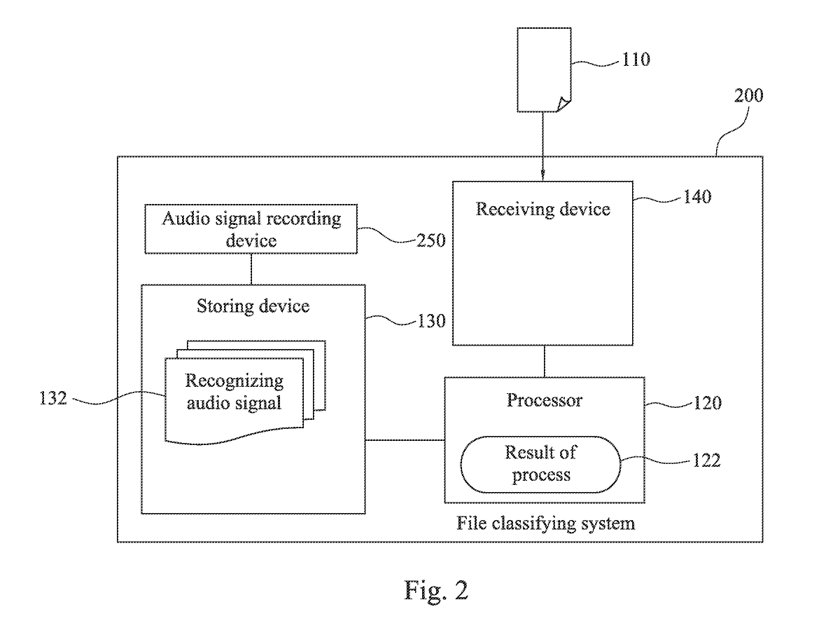

To further describe about the recording method of the recognizing audio signal 132, FIG. 2 shows a file classifying system 200 according to the second embodiment of the present disclosure. The file classifying system 200 has substantially the same hardware as the hardware of the file classifying system 100 in FIG. 1 except for an additional audio recording device 250. In practice, the audio recording device 250 can be microphones or other recording devices; additionally, the audio recording device 250 can also be integrated with the built-in or externally connected audio recording devices of the receiving device 140 so as to become a single device according to the actual demands.

Before the audio file or the video file 110 is recorded, users (for example: speakers) can previously record the above-mentioned recognizing audio signal 132 as a sample reference for voice recognition through the built-in audio recording device 250 in the file classifying system 200, and the operation is simple and convenient. After the audio or video recording is completed, a processor 120 compares a related audio signal correlated to the audio file or the video file 110 with the recognizing audio signal 132 so as to generate a result of process 122, and then automatically classifies the audio file or the video file 110 according to the result of process 122.

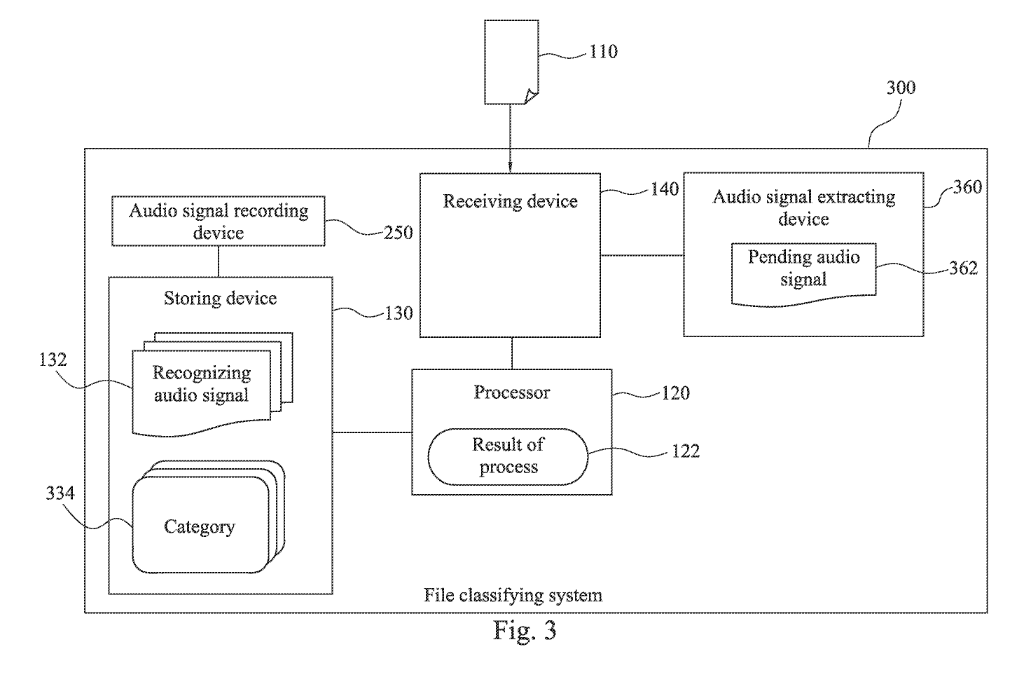

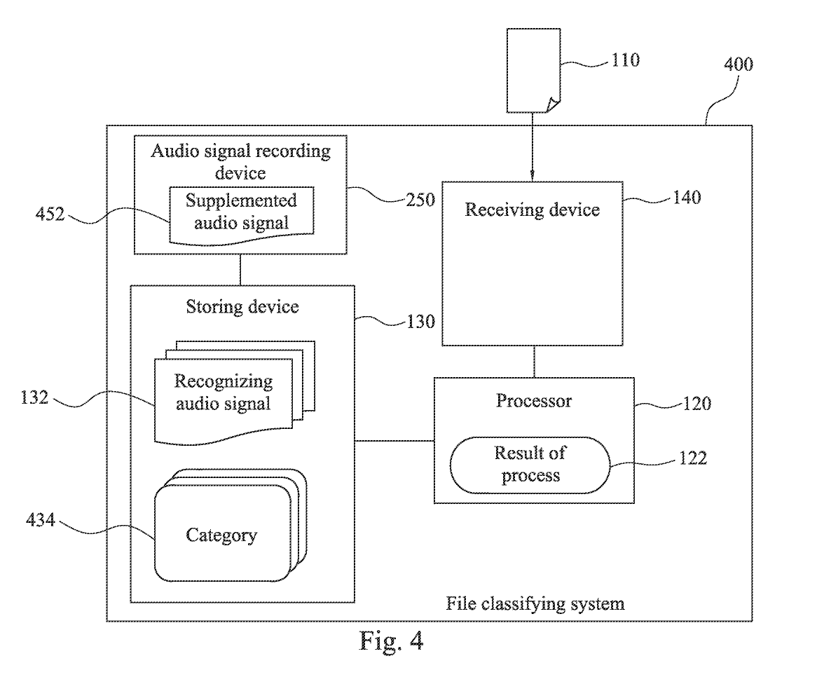

The following are descriptions about the related audio signal examples of the audio file or video file 110 accompanying with FIG. 3 and FIG. 4. FIG. 3 shows a file classifying system 300 according to the third embodiment of the present disclosure. The file classifying system 300 has substantially the same hardware as the hardware of the file classifying system 200 in FIG. 2 except for an additional audio signal extracting device 360. In practice, the audio signal extracting device 360 can be sound cards, audio signal processing chips or other similar components.

After the recording of the audio file or the video file 110 is completed, the audio signal extracting device 360 extracts a pending audio signal 362 from the audio file or the video file 110 as the related audio signal correlated to the audio file or the video file 110. Next, the processor 120 compares the pending audio signal 362 with the recognizing audio signal 132 so as to generate a result of process 122, and then automatically classifies the audio file or the video file 110 according to the result of process 122.

Regarding the specifically implementing methods, in an embodiment, before the audio or video recording, speakers can manipulate the file classifying system 300 or external computer devices to customize an individual category 334 (for example: a folder in Windows operating system), store category 334 in the storing device 130, correlate a path of the category 334 with the recognizing audio signal 132; after the recording of the audio file or the video file 110 is completed, the processor 120 analyzes and compares acoustic features of the pending audio signal 362 with acoustic features of the recognizing audio signal 132; when the acoustic features of the pending audio signal 362 and the acoustic features of the recognizing audio signal 132 are matched, the processor 120 classifies the audio file or the video file 110 into the category 334.

In an alternative embodiment, after the recording of the audio file or the video file 110 is completed, the processor 120 analyzes and compares semantic features of the pending audio signal 362 with semantic features of the recognizing audio signal 132; when the semantic features of the pending audio signal 362 and the semantic features of the recognizing audio signal 132 are matched, the processor 120 classifies the audio file or the video file 110 into the category 334.

In the voice recognition mechanism of the file classifying system 300, the above-mentioned acoustic features are, for example, the ratio of the human voice to the background sound can be used to assist in the determination of implementing scene recognition or human voice recognition; scene recognition can be implemented by using the properties of the background sound to make an assumption about the surrounding objects and the happened events; human voice recognition can be implemented by taking features of tone quality (for example: voice print) as the basis of comparison. The semantic features are, for example, keywords in the recognizing audio signal, commonly used words, sentences or names, and so forth. The above-mentioned acoustic features and semantic features are not limited to the range of illustrations, and any acoustic feature or semantic feature that can be used as a basis of scene recognition should be included in the range of the present disclosure.

In addition to the pending audio signal 362 can be used as the related audio signal correlated to the audio file or the video file 110, another example of the related audio signal is as shown in FIG. 4, which is a schematic diagram of a file classifying system 400 according to the fourth embodiment of the present disclosure. The file classifying system 400 has substantially the same hardware as the hardware of the file classifying system 200 in FIG. 2.

After the recording of the audio file or the video file 110 is completed, a speaker says a sentence as a supplemented audio signal 452 and an audio signal recording device 250 receives the supplemented audio signal 452 as the above-mentioned related audio signal correlated to the audio file or the video file 110; next, a processor compares the supplemented audio signal 452 with a recognizing audio signal 132 so as to generate a result of process 122, and then automatically classifies the audio file or the video file 110 according to the result of process 122.

Regarding the specifically classifying method, in an embodiment, before the audio or video recording, speakers can manipulate the file classifying system 400 or external computer devices to customize an individual category 434 (for example: a folder in Windows operating system), store category 434 in the storing device 130, correlate a path of the category 434 with the recognizing audio signal 132; after the recording of the audio file or the video file 110 is completed, the processor 120 analyzes and compares acoustic features of the supplemented audio signal 452 with acoustic features of the recognizing audio signal 132; when the acoustic features of the supplemented audio signal 452 and the acoustic features of the recognizing audio signal 132 are matched, the processor 120 classifies the audio file or the video file 110 into the category 434.

In an alternative embodiment, after the recording of the audio file or the video file 110 is completed, the processor 120 analyzes and compares semantic features of the supplemented audio signal 452 with semantic features of the recognizing audio signal 132; when the semantic features of the supplemented audio signal 452 and the semantic features of the recognizing audio signal 132 are matched, the processor 120 classifies the audio file or the video file 110 into the category 434.

In the voice recognition mechanism of the file classifying system 400, the acoustic features are, for example, the ratio of the human voice and the background sound can be used to assist in the determination of implementing scene recognition or human voice recognition; scene recognition can be implemented by using the properties of the background sound to make an assumption about the surrounding objects and the happened events; human voice recognition can be implemented by taking features of tone quality (for example: voice print) as the basis of comparison. The semantic features are, for example, keywords in the recognizing audio signal, commonly used words, sentences or names, and so forth. The above-mentioned acoustic features and semantic features are not limited to the range of illustrations, and any acoustic feature or semantic feature that can be used as a basis of scene recognition should be included in the range of the present disclosure.

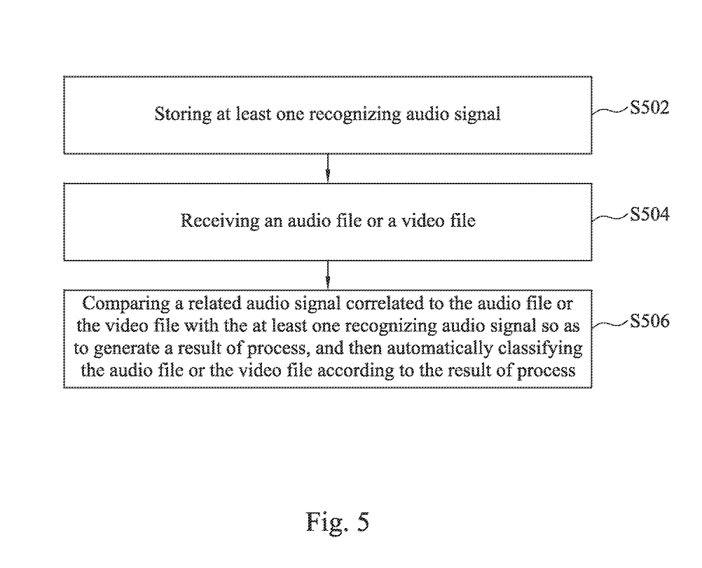

FIG. 5 shows a flow chart of a file classifying method according to the fifth embodiment of the present disclosure. The file classifying method 500 is executable by a computer system, such as the above-mentioned file classifying systems 100, 200, 300, or 400, and parts of functions also can be implemented as at least one computer program stored in computer readable media; the at least one computer program includes a plurality of commands, which are executed on a computer to make the computer execute the file classifying method 500.

As shown in FIG. 5, the file classifying method 500 includes a plurality of steps S502-S506. However, those skilled in the art should understand that the mentioned steps in the present embodiment are in an adjustable execution sequence according to the actual demands except for the steps in a specially described sequence, and even the steps or parts of the steps can be executed simultaneously. Because the hardware used to implement the steps are specifically disclosed in the above embodiments, therefore the description will not be made repeatedly.

First, before the audio or video recording, in step S502, a recognizing audio signal is recorded and stored as a reference sample for voice recognition, and the recognizing audio signal can be voice of users (for example: speakers). Next, after the audio or video recording is completed, in step S504, an audio file or a video file is received and the system shows a request notification or the speakers select an audio category; then, in step S506, a related audio signal correlated to the audio file or the video file is compared with the recognizing audio signal so as to generate a result of process, and then the audio file or the video file is automatically classified according to the result of process. Consequently, files are classified rapidly without the complicatedly manual operation through the voice recognition mechanism of the file classifying method 500.

Specifically, before the audio or video recording, speakers can manipulate the computer system to customize an individual category (for example: a folder in Windows operating system), in step S502, a path of the category is correlated with the recognizing audio signal. In step S506, if the related audio signal correlated to the audio file or the video file and the recognizing audio signal are matched, which indicates that the audio file or the video file is the speaker's individual audio or video recording, and then the processor automatically classifies the audio file or the video file into the customized category by the speaker.

There are at least two implementing methods of the above-mentioned related audio signal, regarding the first implementing method, in an embodiment, in step S506, a pending audio signal is extracted from the audio file or the video file as the related audio signal, acoustic features of the pending audio signal are analyzed and compared with acoustic features of the at least one recognizing audio signal, and when the acoustic features of the pending audio signal and the acoustic features of the at least one related audio signal are matched, the audio file or the video file is classified into the category.

In an alternative embodiment, in step S506, semantic features of the pending audio signal are analyzed and compared with semantic features of the at least one recognizing audio signal, and when the semantic features of the pending audio signal and the semantic features of the at least one related audio signal are matched, the audio file or the video file is classified into the category.

Regarding the second implementing method, in step S506, a supplemented audio signal is received as the related audio signal, wherein the supplemented audio signal can be a sentence said by the speaker after the audio or video recording is completed; then, acoustic features of the at least one recognizing audio signal is analyzed and compared with acoustic features of the supplemented audio signal, and when the acoustic features of the at least one recognizing audio signal and the acoustic features of the supplemented audio signal are matched, the audio file or the video file is classified into the category.

In an alternative embodiment, in step S506, semantic features of the at least one recognizing audio signal is analyzed and compared with semantic features of the supplemented audio signal, and when the semantic features of the at least one recognizing audio signal and the semantic features of the supplemented audio signal are matched, the audio file or the video file is classified into the category.

In the above-mentioned step S506, when acoustic features are analyzed and compared by using frequency, frequency spectrum, amplitude, phase, duration, voice print of the audio signal, any combination thereof, results of mathematical manipulation, or results of time domain to frequency domain transform as the basis of analysis and comparison and should be included in the range of the present disclosure. Scene recognition can be implemented by recognizing the surrounding objects, for example, stepping sound of different kinds of shoes, different transportation vehicles, different animal sounds, and so forth; the happened events can also be recognized as, for example, the sound of the wind, the sound of the rain, the sound of the door opening and closing, different types of music, and so forth; human voice recognition can be implemented according to the pitch, accent, rhythm, volume, tone quality of different people, and so forth, to recognize the uniqueness of different people. Users can define the strength of matching conditions and an order of the determination conditions according to demands and store them in the storing device. Any acoustic feature that can be used as a basis of scene recognition or human voice recognition should be included in the range of the present disclosure.

In the above-mentioned step S506, when semantic features are analyzed, methods include recognizing keywords in the recognizing audio signal, for example, terms of different sports, terms of different situations (such as speech, wedding ceremony, graduation ceremony, concert, and so on) can be used for scene recognition; human voice recognition can be implemented by using commonly used words, sentences, names, or relationship terms, and so forth. The above-mentioned strength of matching conditions is exemplarily described as follows. Hypernym and hyponym, synonym, similar concepts, words translated in different languages, names in different languages, or a part of name can all be defined as strongly matched. The strength of matching conditions and an order of the determination conditions can be adjusted according to demands and stored in the storing device.

In the above-mentioned step S506, classification can be automatically executed according to the result of process or through a category suggestion that users can confirm the result of process and flexibly adjust the classification according to users' demands; for example, a type of classification is moving the file into a folder in Windows operating system.

In conclusion, the present disclosure can classify files into appropriate categories immediately after every audio or video recording is completed through the above-mentioned embodiments so as to solve the problems of quickly finding a particular file from the numerous files in the situation of the large number of files without the regular arrangement, and avoid the trouble of manual file classification.

Even though the present disclosure is disclosed as above, the disclosure is not used to limit the present disclosure. It will be apparent to those skilled in the art that various modifications and variations can be made to the present disclosure without departing from the spirit or scope of the invention; thus, it is intended that the range protected by the present disclosure should refer to the scope of the following claims.

What is claimed is:

1. A file classifying system, comprising:
a storing device configured to store at least one recognizing audio signal;
a receiving device configured to receive an audio file or a video file; and
a processor configured to compare a related audio signal correlated to the audio file or the video file with the at least one recognizing audio signal so as to generate a result of process, and then automatically classify the audio file or the video file according to the result of process.

2. The file classifying system of claim 1, further comprising:
an audio signal recording device configured to record at least one recognizing audio signal before the audio file or the video file is recorded.

3. The file classifying system of claim 2, further comprising:
an audio signal extracting device configured to extract a pending audio signal as the related audio signal from the audio file or the video file.

4. The file classifying system of claim 3, wherein the storing device stores at least one category, the processor correlates a path of the at least one category with the at least one recognizing audio signal;
after a recording of the audio file or the video file is completed, the processor analyzes and compares acoustic features of the pending audio signal with acoustic features of the at least one recognizing audio signal; when the acoustic features of the pending audio signal and the acoustic features of the at least one recognizing audio signal are matched, the processor classifies the audio file or the video file into the at least one category.

5. The file classifying system of claim 3, wherein the storing device stores at least one category, the processor correlates a path of the at least one category with the at least one recognizing audio signal;
after a recording of the audio file or the video file is completed, the processor analyzes and compares semantic features of the pending audio signal with semantic features of the at least one recognizing audio signal; when the semantic features of the pending audio signal and the semantic features of the at least one recognizing audio signal are matched, the processor classifies the audio file or the video file into the at least one category.

6. The file classifying system of claim 1, further comprising:
an audio recording device configured to receive a supplemented audio signal as the related audio signal after the audio file or the video file is recorded.

7. The file classifying system of claim 6, wherein the storing device stores at least one category, the processor correlates a path of the at least one category with the at least one recognizing audio signal;
after a recording of the audio file or the video file is completed, the processor analyzes and compares acoustic features of the at least one recognizing audio signal with acoustic features of the supplemented audio signal; when the acoustic features of the at least one recognizing audio signal and the acoustic features of the supplemented audio signal are matched, the processor classifies the audio file or the video file into the at least one category.

8. The file classifying system of claim 6, wherein the storing device stores at least one category, the processor builds correlates a path of the at least one category with the at least one recognizing audio signal;
after a recording of the audio file or the video file is completed, the processor analyzes and compares semantic features of the at least one recognizing audio signal with semantic features of the supplemented audio signal; when the semantic features of the at least one recognizing audio signal and the semantic features of the supplemented audio signal are matched, the processor classifies the audio file or the video file into the at least one category.

9. A file classifying method, comprising:
(a) storing at least one recognizing audio signal;
(b) receiving an audio file or a video file; and
(c) comparing a related audio signal correlated to the audio file or the video file with the at least one recognizing audio signal so as to generate a result of process, and then automatically classifying the audio file or the video file according to the result of process.

10. The file classifying method of claim 9, wherein the step (a) comprises:
recording at least one recognizing audio signal before the audio file or the video file is recorded.

11. The file classifying method of claim 10, wherein the step (c) comprises:
extracting a pending audio signal as the related audio signal from the audio file or the video file.

12. The file classifying method of claim 11, wherein the step (a) comprises: correlating a path of the at least one category with the at least one recognizing audio signal; the step (c) comprises: after a recording of the audio file or the video file is completed, analyzing and comparing acoustic features of the pending audio signal with acoustic features of the at least one recognizing audio signal; when the acoustic features of the pending audio signal and the acoustic features of the at least one recognizing audio signal are matched, classifying the audio file or the video file into the at least one category.

13. The file classifying method of claim 11, wherein the step (a) comprises: correlating a path of the at least one category with the at least one recognizing audio signal; the step (c) comprises: after a recording of the audio file or the video file is completed, analyzing and comparing semantic features of the pending audio signal with semantic features of the at least one recognizing audio signal; when the semantic features of the pending audio signal and the semantic features of the at least one recognizing audio signal are matched, classifying the audio file or the video file into the at least one category.

14. The file classifying method of claim 9, wherein the step (c) comprises:
receiving a supplemented audio signal as the related audio signal after the audio file or the video file is recorded.

15. The file classifying method of claim 14, wherein the step (a) comprises: correlating a path of the at least one category with the at least one recognizing audio signal; the step (c) comprises: after a recording of the audio file or the video file is completed, analyzing and comparing acoustic features of the at least one recognizing audio signal with acoustic features of the supplemented audio signal; when the acoustic features of the at least one recognizing audio signal and the acoustic features of the supplemented audio signal are matched, classifying the audio file or the video file into the at least one category.

16. The file classifying method of claim 14, wherein the step (a) comprises: correlating a path of the at least one category with the at least one recognizing audio signal; the step (c) comprises: after the recording of the audio file or the video file is completed, analyzing and comparing semantic features of the at least one recognizing audio signal with semantic features of the supplemented audio signal; when the semantic features of the at least one recognizing audio signal and the semantic features of the supplemented audio signal are matched, classifying the audio file or the video file into the at least one category.
